(19) United States
(12) Patent Application Publication
(10) Pub. No.: US 2012/0144501 A1
(43) Pub. Date: Jun. 7, 2012

(54) REGULATING ACCESS TO PROTECTED DATA RESOURCES USING UPGRADED ACCESS TOKENS

(75) Inventors: Alan Vangpat, Pittsburgh, PA (US); William Charles Mortimore, JR., San Fransicso, CA (US)

(73) Assignee: SALESFORCE.COM, INC., San Francisco, CA (US)

(21) Appl. No.: 13/088,908

(22) Filed: Apr. 18, 2011

Related U.S. Application Data
(60) Provisional application No. 61/419,340, filed on Dec. 3, 2010.

(51) Int. Cl. G06F 21/24

(52) U.S. Cl. 726/28

(57) ABSTRACT

Various techniques and procedures related to client authorization and the management of protected data resources are presented here. One approach employs a computer-implemented method of regulating access to protected data resources. In accordance with this approach, a client sends a first access token to a server, the first access token having first data access attributes associated therewith. In response to receiving the first access token, the server sends a second access token to the client module, the second access token having second data access attributes associated therewith. The second data access attributes represent expanded or additional data access capabilities granted to the client. The client may then access protected data resources using the second data access token.

### CROSS-REFERENCE TO RELATED APPLICATION(S)

This application claims the benefit of U.S. provisional patent application Ser. No. 61/419,340, filed Dec. 3, 2010.

### TECHNICAL FIELD

Embodiments of the subject matter described herein relate generally to data processing systems and techniques, such as systems and processes that use a common network-based platform to support applications executing on behalf of multiple tenants. More particularly, embodiments of the subject matter relate to techniques, protocols, and methodologies for regulating access to protected data resources.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

In certain situations, it may be necessary or desirable to grant access to secure or protected data. If the “owner” of the protected data resources seeks access, then user credentials may be used (e.g., a username and password). If a “non-owner” of the protected data resources seeks access, then the non-owner could use the owner's credentials to gain access. Alternatively, authorization or authentication techniques or protocols could be employed to provide regulated access to the non-owner. For example, the OAuth authorization protocol could be used such that the owner's credentials need not be disclosed to the non-owner. In this regard, the OAuth authorization protocol calls for the use of access tokens that enable non-owners to access protected data resources without knowledge of the owner's credentials. The scope, duration, and amount of data access enabled by an access token can be configured and controlled as needed to limit, restrict, and/or prevent access to certain data if so desired.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary multi-tenant data processing system;

FIG. 2 is a diagram that illustrates an exemplary protocol flow associated with the access of protected data resources; and

FIG. 3 is a flow chart that illustrates an exemplary embodiment of a data access regulation process.

### DETAILED DESCRIPTION

The exemplary embodiments presented here relate to various user authentication techniques, protocols, procedures, and technology. The described subject matter can implemented in the context of any computer-implemented system, such as a software-based system, a database system, a multi-tenant environment, or the like. Moreover, the described subject matter could be implemented in connection with two or more separate and distinct computer-implemented systems that cooperate and communicate with one another.

In accordance with one exemplary embodiment described below, a client module or application can “exchange” one access token for another access token, where the original access token is associated with relatively restricted or limited data access capabilities. The original access token is exchanged for one with expanded or enhanced data access capabilities. Thus, the client module or application can legitimately access more data, data for a longer period of time, or the like, using the “upgraded” access token. Although not always required, the techniques and technologies described below are suitable for use with the OAuth authorization protocol, in particular, the OAuth 2.0 protocol. Accordingly, the exemplary embodiment presented here is described in the context of an OAuth deployment. However, it should be understood that the disclosed subject matter may also be utilized with other data access, authorization, and authentication protocols, specifications, and approaches.

The OAuth authorization protocol specifies a way that allows a client to gain access to a resource owner's protected resources without actually using the resource owner's credentials. Rather, the client obtains an access token that denotes a specific scope, duration, and other access attributes associated with the resource owner's data. The OAuth 2.0 protocol specifies many existing flows between the client, the resource owner, the authorization server, and the resource server. The latest draft of the OAuth 2.0 specification is currently available online at: tools.ietf.org/html/draft-ietf-oauth-v2-13. The relevant content of the OAuth 2.0 specification is incorporated by reference herein.

Some service providers may include implementations of the OAuth 2.0 authorization protocol that provide access tokens that are limited in scope. For example, in some implementations these access tokens are not allowed to be used to make user interface (UI) based requests for data. Hence, the service providers may wish to provide a way for consumers to be able to exchange the usual access token for an access token that is usable anywhere (including in the UI). Moreover, the service providers may want to do this in a secure way, such that they can limit which consumers are able to make this exchange.

In one embodiment presented herein, although the service provider normally limits access from sessions obtained through the OAuth protocol, a flow type is used to circumvent that restriction. The differentiation is that this flow type has not been previously defined—the OAuth specification does not specify a way to exchange access tokens for other access tokens. While the approach presented here is built on top of the assertion flow (and therefore shares some of the common potions of the OAuth specification), it is an entirely new type. It does, however, provide the general “assertion flow” where the client can present some sort of identifying token and get back an access token. In one embodiment presented herein, a service provider can build on top of that flow by having the identifying token be another access token.

In one exemplary implementation, a service provider employs the OAuth 2.0 login protocol (which is a public protocol). The service provider also provides a way for customers to create a “Remote Access” object, which allows them to configure information such as a contact email address, application name, and image. Users are able to use this object with an OAuth-capable client to obtain access tokens.

The OAuth login protocol specifies a generic “Assertion Flow,” and includes a specification for use with Security Assertion Markup Language (SAML) assertions. By doing so, in one implementation, a service provider can provide an alternate specification for the flow, where the assertion is an OAuth 2.0 access token and the response provides a generally-usable or less restricted session.

In one application, normal OAuth 2.0 access tokens are restricted because they cannot be used to obtain UI access to protected data. In contrast, the enhanced flow presented here allows consumers to use OAuth to obtain UI sessions. In one embodiment, access is controlled via a whitelist. In this way, consumers are able to obtain sessions that can be used in the UI. In other embodiments, access is controlled via a setting on the consumer object. In yet other embodiments, access may be controlled in a different way.

Using assertion flow, a consumer can obtain an access token. The consumer can either make an out-of-band POST request, or redirect on the front channel with a GET request to the token endpoint. In one embodiment, such a request could include parameters such as, without limitation:

“grant_type”—this must be ASSERTION for this flow;

“assertion”—this is the valid OAuth 2.0 access token;

“assertion_type”—this could be, for example: sfdc:oauth2:access_token;

“client_id”—this is the consumer key from the remote access object;

“startURL”—this optional parameter is the URL to send the user to after the redirect, and this URL is subject to the usual redirect filter criteria;

“format”—this optional parameter is the expected return format from the servlet, and standard OAuth Headers and Parameters can be used to define this parameter.

In one embodiment, a response to such a POST request could include the following parameters, without limitation:

“access_token”—this is a short-lived SID, i.e., an upgraded access token with expanded capabilities;

“redirect”—this is a URL that is only valid for a limited amount of time, and one that the client should redirect to on the front channel, and which properly sets UI cookies in the user's browser.

In one embodiment, a response to such a GET request could be a 302 redirect.

In one implementation, the service provider additionally validates that the OAuth 2.0 access tokens passed into the flow were created for the specified consumer.

In accordance with one embodiment, the service provider provides an alternate handler for the assertion flow type in OAuth 2.0. Using the “assertion_type” parameter provided in the specification, the service provider is able to add a token type, for instance, “sfdc:oauth2:access_token” type.

When a service provider receives an access token in this flow, the service provider validates that the access token is valid. This can be done by doing a lookup of the organization where the access token was created. An internal callout may also be done to the organization's instance to validate that the access token is valid. If it is valid, a new session is cloned from the access token session, with no restrictions on its use.

The client, in one implementation, can also specify a “start URL” for a location to send the user. For example, a client can use this flow with a start URL of /home/home.jsp. The result is a redirect that sends the user to /home/home.jsp after logging in. In one embodiment, this is done using the service provider's existing mechanisms for redirects after login, with a URL parameter.

Various embodiments allow customers with existing investments in single sign-on software, integration, security, configuration, and trust already established with a service provider for web single sign-on, to reuse those techniques and mechanisms for the application programming interface (API). In other words, the exact same authentication infrastructure is reusable in an entirely new integration context.

In one embodiment, the service provider adds a new type on top of the OAuth assertion flow, in addition to using it to create an unrestricted session.

Another interesting aspect of the flow type presented here relates to an embodiment that restricts original access tokens to API access. In such an embodiment, the flow type presented here is intended to act as a bridge between the API world and the UI world, it allows consumers to specify where users get sent after a successful exchange.

As described in more detail below, exemplary methods and systems can be used to provide mechanisms to access data via an authentication infrastructure, and those mechanisms can be utilized by a client to access the data.

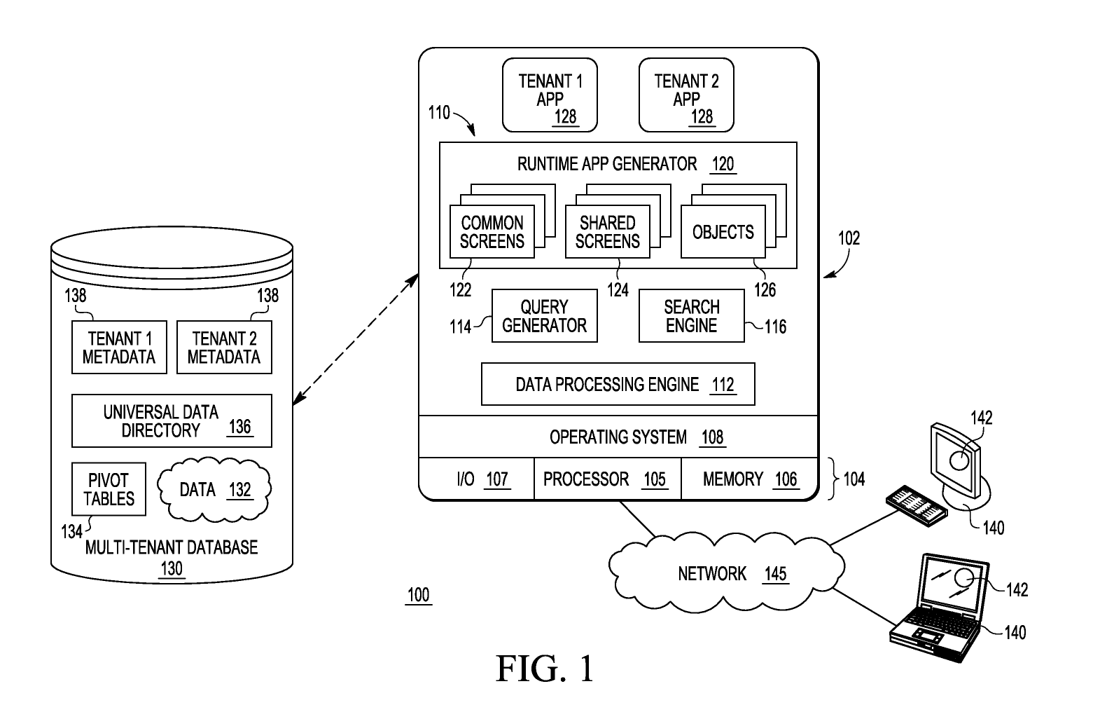

Turning now to FIG. 1, an exemplary multi-tenant application system 100 suitably includes a server 102 that dynamically creates virtual applications 128 based upon data 132 from a common database 130 that is shared between multiple tenants. Data and services generated by the virtual applications 128 are provided via a network 145 to any number of user devices 140, as desired. Each virtual application 128 is suitably generated at run-time using a common application platform 110 that securely provides access to the data 132 in the database 130 for each of the various tenants subscribing to the system 100. In accordance with one non-limiting example, the system 100 may be implemented in the form of a multi-tenant customer relationship management system that can support any number of authenticated users of multiple tenants.

A “tenant” or an “organization” generally refers to a group of users that shares access to common data within the database 130. Tenants may represent customers, customer departments, business or legal organizations, and/or any other entities that maintain data for particular sets of users within the system 100. Although multiple tenants may share access to the server 102 and the database 130, the particular data and services provided from the server 102 to each tenant can be securely isolated from those provided to other tenants. The multi-tenant architecture therefore allows different sets of users to share functionality without necessarily sharing any of the data 132.

The database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

The data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 is implemented using one or more actual and/or virtual computing systems that collectively provide the dynamic application platform 110 for generating the virtual applications 128. The server 102 operates with any sort of conventional processing hardware 104, such as a processor 105, memory 106, input/output features 107 and the like. The processor 105 may be implemented using one or more of microprocessors, microcontrollers, processing cores and/or other computing resources spread across any number of distributed or integrated systems, including any number of “cloud-based” or other virtual systems. The memory 106 represents any non-transitory short or long term storage capable of storing programming instructions for execution on the processor 105, including any sort of random access memory (RAM), read only memory (ROM), flash memory, magnetic or optical mass storage, and/or the like. The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 106 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The input/output features 107 represent conventional interfaces to networks (e.g., to the network 145, or any other local area, wide area or other network), mass storage, display devices, data entry devices and/or the like. In a typical embodiment, the application platform 110 gains access to processing resources, communications interfaces and other features of the processing hardware 104 using any sort of conventional or proprietary operating system 108. As noted above, the server 102 may be implemented using a cluster of actual and/or virtual servers operating in conjunction with each other, typically in association with conventional network communications, cluster management, load balancing and other features as appropriate.

The application platform 110 is any sort of software application or other data processing engine that generates the virtual applications 128 that provide data and/or services to the user devices 140. The virtual applications 128 are typically generated at run-time in response to queries received from the user devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user devices 140. The virtual applications 128 created by tenants are typically constructed in accordance with the tenant-specific metadata 138, which describes the particular tables, reports, interfaces and/or other features of the particular application. In various embodiments, each virtual application 128 generates dynamic web content that can be served to a browser or other client program 142 associated with its user device 140, as appropriate.

The runtime application generator 120 suitably interacts with the query generator 114 to efficiently obtain multi-tenant data 132 from the database 130 as needed. In a typical embodiment, the query generator 114 considers the identity of the user requesting a particular function, and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user that initiated the request.

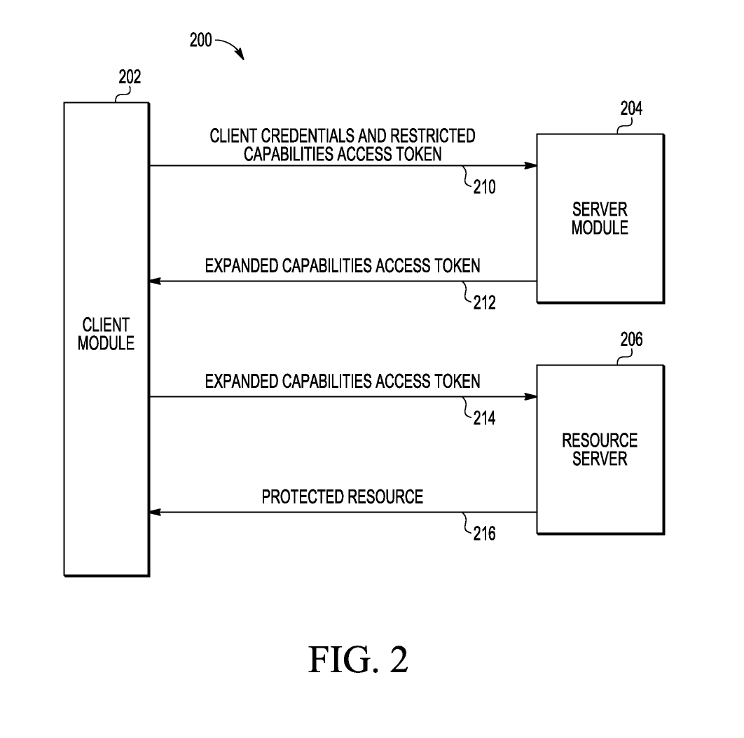

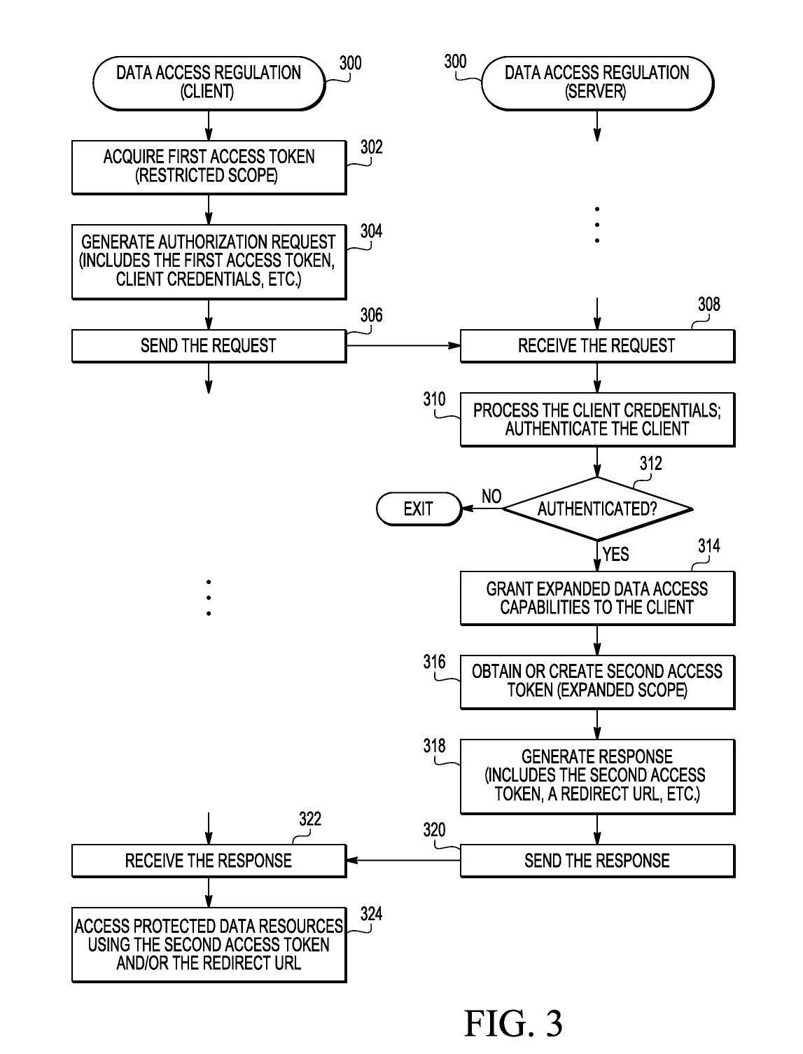

The data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc. In certain embodiments, the data processing engine 112 and the processor 105 cooperate in an appropriate manner to perform and manage the various user authentication, access token processing, data access granting, and other techniques, processes, and methods described in more detail below with reference to FIG. 2 and FIG. 3.

In operation, developers use the application platform 110 to create data-driven virtual applications 128 for the tenants that they support. Such virtual applications 128 may make use of interface features such as tenant-specific screens 124, universal screens 122 or the like. Any number of tenant-specific and/or universal objects 126 may also be available for integration into tenant-developed virtual applications 128. The data 132 associated with each virtual application 128 is provided to the database 130, as appropriate, and stored until it is requested or is otherwise needed, along with the metadata 138 that describes the particular features (e.g., reports, tables, functions, etc.) of that particular tenant-specific virtual application 128.

The data and services provided by the server 102 can be retrieved using any sort of personal computer, mobile telephone, tablet or other network-enabled user device 140 on the network 145. Typically, the user operates a conventional browser or other client program 142 to contact the server 102 via the network 145 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. The query generator 114 suitably obtains the requested data 132 from the database 130 as needed to populate the tables, reports or other features of the particular virtual application 128. As noted above, the virtual application 128 may contain Java, ActiveX, or other content that can be presented using conventional client software running on the user device 140; other embodiments may simply provide dynamic web or other content that can be presented and viewed by the user, as desired.

FIG. 2 is a diagram that illustrates an exemplary protocol flow associated with the access of protected data resources. FIG. 2 depicts a simplified system environment 200 having a client module 202, a server module 204, and a resource server 206. Although not depicted in FIG. 2, the system environment 200 could be deployed in the context of a multi-tenant application system, such as the system 100 described above. Moreover, FIG. 2 depicts functional modules that might be realized using, for example, one or more processors, a data processing engine, or other computer-implemented logic resident at the system environment 200. In this regard, the client module 202 may represent, without limitation: a piece of hardware (such as a computer, a mobile electronic device, or any processor-based computing device); a functional, logical, or processing module of a piece of hardware; a software-based application that executes at a piece of hardware; or the like. In certain embodiments, the client module 202 may be realized as a web-based application, a desktop application, an object-oriented script running on a webpage, or the like, which is suitably designed to perform the various client module tasks, processes, and procedures described in more detail herein. FIG. 2 depicts only one client module 202 in the system environment 200. In practice, however, the server module 204 and/or the resource server 206 may support a plurality of different client modules.

The server module 204 and/or the resource server 206 may represent, without limitation: a piece of hardware (such as a computer, a mobile electronic device, or any processor-based computing device); a functional, logical, or processing module of a piece of hardware; a software-based application that executes at a piece of hardware; or the like. In certain embodiments, the server module 204 is suitably designed to perform the various server module tasks, processes, and procedures described in more detail herein. In practice, the server module 204 may be realized as a web-based application.

The resource server 206 is suitably designed to host the protected data and to provide access to the protected data in accordance with certain data access attributes associated with access tokens received from the client module 202. In this context, the resource server 206 may function as set forth in the OAuth 2.0 authorization protocol to provide access to protected data without directly using the credentials (e.g., username and password) of the end user. Notably, although the server module 204 and the resource server 206 are depicted as distinct elements, the two could be realized as a single logical element, module, or hardware device.

FIG. 2 generally depicts an exemplary protocol flow supported by the client module 202 and the server module 204. In accordance with this protocol flow, the client module 202 can exchange one access token for a different access token that is associated with expanded, upgraded, or enhanced data access rights, privileges, or capabilities (relative to the original access token). As used in this description, an “access token” is digital data that represents an authorization issued to an entity, application, module, or element that seeks access to protected data, to access system features, to access system functionality, and the like. Depending upon the particular application, system environment, or context, any of the following terms could be used interchangeably with “access token”-“session,” “UI session,” or “session key.” For simplicity, the following description consistently refers to “access token” rather than any of these alternate terms.

In practice, an access token can be realized as a string of bits that defines or otherwise indicates, without limitation: a scope of data access granted to the token holder; a duration of data access granted to the token holder; data access capabilities granted to the token holder; and/or particular system features or functionality accessible to the token holder. The data access attributes associated with an access token can be designated and granted by the owner of the protected resources. Moreover, access tokens can be processed by the server module 204 and/or by the resource server 206 as needed to implement the desired data protection schemes. In this regard, the data access attributes corresponding to an access token may be static and fixed, or they may be dynamic and responsive to certain authorization rules or protocols employed by the system. For example, the data access attributes associated with a particular access token might vary in accordance with the date, time, user identity, user classification, system status, system condition, or the like.

In accordance with the generalized flow shown in FIG. 2, the client module 202 sends a first access token to the server module 204. The first access token is considered to be one that is associated with restricted or otherwise limited data access capabilities. In other words, the client module 202 has restricted access to protected resources when using the first access token. The client module 202 also sends its credentials and/or an assertion to the server module 204 (for example, the client module 202 may send a SAML assertion to the server module 204 for purposes of authentication). The arrow 210 represents the sending, transfer, or routing of the restricted capabilities access token (along with the client credentials and/or the assertion) to the server module 204.

The server module 204 processes the client credentials and/or the assertion to validate the client module 202. Assuming that the client module 202 is authenticated, the server module 204 creates, retrieves, or otherwise obtains a second access token for the client module 202. The second access token is considered to be one that is associated with expanded, enhanced, or increased data access capabilities granted to the client module 202. The server module 204 sends the expanded capabilities access token to the client module 202. The arrow 212 represents the sending, transfer, or routing of the expanded capabilities access token to the client module 202.

The client module 202 processes the response received from the server module 204 in an appropriate manner that allows it to access protected resources, which may be maintained by the resource server 206. The client module 202 may employ various mechanisms (e.g., those described in more detail below) to access the protected resources using the expanded capabilities access token. For example, the client module 202 may generate and send a data access request to the resource server 206. The data access request may include the expanded capabilities access token, as shown in FIG. 2. In this regard, the arrow 214 represents the sending, transfer, or routing of the expanded capabilities access token to the resource server 206.

The resource server 206 processes the data access request and the expanded capabilities access token in an appropriate manner. This example assumes that the resource server 206 serves the request by sending the requested protected data to the client module 202 or by otherwise providing access to the requested protected data. The arrow 216 represents the serving of the client module request. For this example, some of the protected resources regulated by the resource server 206 are not accessible to the client module 202 using only the restricted capabilities access token. Instead, those protected resources are accessible to the client module 202 using the expanded capabilities access token. As another example, data accessed using the restricted capabilities access token may only be available for a relatively short period of time (e.g., ten minutes), while data accessed using the expanded capabilities access token may be available for a comparatively longer period of time (e.g., an hour).

FIG. 3 is a flow chart that illustrates an exemplary embodiment of a data access regulation process 300. The various tasks performed in connection with the process 300 may be performed by software, hardware, firmware, or any combination thereof. For illustrative purposes, the following description of the process 300 may refer to elements mentioned above in connection with FIG. 1 and FIG. 2. In practice, portions of the process 300 may be performed by different elements of the described system, e.g., a server system, a server module, a resource server, a client system, a client module, or the like. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

For this particular embodiment, certain tasks of the process 300 are performed by a client module, while other tasks are performed by a server module. Accordingly, the left side of FIG. 3 corresponds to tasks performed by the client module, and the right side of FIG. 3 corresponds to tasks performed by the server module. The process 300 assumes that the client module has already acquired or obtained an access token, which is referred to herein as the “first access token” or the “restricted capabilities access token” (task 302). For instance, the client module might obtain the first access token via a previous OAuth protocol flow. The first access token has certain data access attributes associated therewith. As mentioned above, the data access attributes of the first access token may define, without limitation: a first (e.g., limited or restricted) scope of data access granted to the client module; a first (e.g., short) duration of data access granted to the client module; a first (e.g., limited, restricted, or lesser) data access capabilities granted to the client module; and/or a first set of features or functions available to the client module. In this regard, the data access attributes of the first access token may be designated, specified, or otherwise configured by a service provider to regulate the manner in which protected data may be accessed by a client module or application. As one non-limiting example, the first access token may allow client access to protected data via the API of the service provider, while disallowing client access to protected data via a UI such as a web browser application.

The process 300 assumes that the client module desires to access protected data that is managed or otherwise regulated by the server module. To this end, the client module may generate a suitably formatted and populated authorization request (task 304). For this exemplary embodiment, the authorization request includes or is otherwise generated with the first access token. In certain embodiments, the authorization request also includes or is generated with credentials of the client module, where the credentials facilitate authentication of the client module. Alternatively (or additionally), the authorization request includes or is generated with an assertion for the client module, where the assertion facilitates authentication of the client module. As one non-limiting example, the assertion could be a SAML assertion. Depending upon the implementation, the authorization request might include additional information, parameters, or data as needed or desired.

In accordance with one practical embodiment, the authorization request may be a POST request or a GET request. A “POST request” refers to a Hypertext Transfer Protocol (HTTP) technique where a client sends data to be processed to a server as part of its request; the data is included in the body of the POST request. In contrast, a “GET request” refers to an HTTP technique where a URL and headers are sent to the server; a GET request specifies or otherwise identifies a particular resource. As mentioned above, a POST request or a GET request may also include certain parameters that are used by the server module when interpreting the authorization request. These parameters may include some or all of the following, without limitation: “grant_type” (for this example, grant_type=ASSERTION); “assertion” (the value of the “assertion” parameter is the first access token described above); “assertion_type” (this parameter may be used to specify in more detail what the particular assertion is intended for); “client_id” (a key or identifier that identifies the client module to the server module); “startURL” (this is a URL of a specific page to access after completion of the flow); and “format” (this specifies the format of the returned data).

The illustrated embodiment of the process 300 continues by sending the authorization request (e.g., a POST request or a GET request) from the client module to the server module (task 306). Notably, task 306 represents the sending of the first access token, the client credentials, and/or the assertion from the client module. The process 300 assumes that the server module successfully receives the authorization request on behalf of the client module (task 308). Consequently, task 308 is associated with receiving, at the server module: the first access token; the client credentials; and/or the assertion sent on behalf of the client module. Upon receipt of these items, the server module processes the client credentials and/or the assertion in an appropriate manner for authenticating the client module (task 310). If the client module is not authenticated (query task 312), then the process may terminate or exit. Moreover, the client credentials could be analyzed to determine whether or not the client module is allowed to exchange its original access token for an expanded access token. Thus, the server module might maintain or consult a list or database that indicates whether or not clients are eligible to upgrade their access tokens. In some embodiments, the system notifies the resource owner when a client attempts to gain expanded access to the resource owner's data, and allows the resource owner to permit or deny expanded data access as desired. Of course, other access control techniques and methodologies could be incorporated into the client authentication process.

This description assumes that the client module is successfully authenticated and is otherwise permitted to obtain an expanded access token. In response to the client authentication, the process 300 may grant expanded, extended, upgraded, enhanced, or otherwise different data access capabilities to the client module, as compared to the data access capabilities associated with the first access token (task 314). The upgraded data access capabilities reflect or define an expanded scope of data access, an extended duration of data access, and/or additional data access capabilities for the client module. The process 300 may continue by obtaining or creating a second access token for the client module (task 316). The second access token may also be referred to herein as the “expanded capabilities access token” or the “upgraded access token.” Relative to the first access token, the second access token has different data access attributes associated therewith. In this regard, the data access attributes of the second access token may define, without limitation: a second (e.g., expanded, extended, or broader) scope of data access granted to the client module, which exceeds the first scope of data access associated with the first access token; a second (e.g., long) duration of data access granted to the client module, which is longer than the first duration of data access associated with the first access token; second (e.g., additional, upgraded, or greater) data access capabilities granted to the client module, which represent expanded data access capabilities, relative to the first data access capabilities associated with the first access token; and/or a second set of features or functions available to the client module. In this regard, the data access attributes of the second access token may be designated, specified, or otherwise configured by a service provider to provide more data access rights to the client module. For example, the second access token may allow client access to protected data via the API of the service provider and via a UI such as a web browser application.

The illustrated embodiment of the process 300 continues by generating a suitably formatted and populated response (task 318). For this exemplary embodiment, the response includes or is otherwise generated with the second access token. In certain embodiments, the response also includes or is generated with a redirect URL for the client module. In this regard, the redirect URL (when acted upon by the client module) redirects the client module to a designated resource, such as a web page, to access protected data resources. In certain situations, the response will include the second access token and the redirect URL as two distinct and parsed elements. In other situations, however, the second access token is incorporated with or otherwise embedded in the redirect URL itself. Regardless of the particular implementation, the response will somehow include, identify, or define the second access token in conjunction with the redirect URL. Depending upon the implementation, the response might include additional information, parameters, or data as needed or desired.

In accordance with the exemplary embodiment mentioned above, the format and content of the response generated at task 318 is influenced by the type of authorization request received at task 308. Thus, the server module uses one response format for POST requests, and a different response format for GET requests. More specifically, if a POST request was received, then the response includes a body with at least the second access token and the redirect URL as separate and identifiable elements. In contrast, if a GET request was received, then the response may be formatted as a “302” redirect. In other words, the response includes the redirect URL, which conveys or indicates the second access token such that the response need not distinctly and separately include the second access token.

The illustrated embodiment of the process 300 continues by sending the response from the server module to the client module (task 320). Notably, task 320 represents the sending of the redirect URL and the second access token, which may or may not be separate from the redirect URL. The process 300 assumes that the client module successfully receives the response (task 322). Consequently, task 322 is associated with receiving, at the server module, the redirect URL and the second access token (in conjunction with the redirect URL or parsed from the redirect URL). The response can be received either by the original client (for POST requests) or the end user's web browser or desktop application (for GET requests). If a POST request was issued, the client module is able to use the second access token in the same manner as the first access token. In other words, the second access token effectively serves as a replacement for the first access token. However, the client module is also able to use the second access token by sending the user into the web application with the second access token (which is easily facilitated using the redirect URL that is returned from the server module).

Upon receipt of these items, the client module reacts in an appropriate manner to access protected data resources (task 324). In accordance with one exemplary embodiment, the client module generates a protected data request that includes the second access token, and sends the protected data request to the server module (or to the resource server) to access the desired data. In accordance with another exemplary embodiment, the client module processes the redirect URL, which redirects the client module to a web page, a location, or a resource to access the protected data.

The techniques and methodologies described above enable a client module, device, or application to exchange or upgrade an existing access token for another access token having different (e.g., expanded, extended, broader, or additional) data access capabilities, rights, and/or privileges. Moreover, the exemplary data access flow described above may be implemented in a way that is compatible with the OAuth authorization protocol, in particular, the OAuth 2.0 protocol.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method of regulating access to protected data resources, the method comprising:
sending a first access token from a client module, the first access token having first data access attributes associated therewith; and
in response to sending the first access token, receiving a second access token at the client module, the second access token having second data access attributes associated therewith, the first data access attributes and the second data access attributes being different.

2. The method of claim 1, further comprising generating a protected data request with the client module, the protected data request including the second access token.

3. The method of claim 1, wherein:
the first data access attributes define a first scope of data access granted to the client module;
the second data access attributes define a second scope of data access granted to the client module; and
the second scope of data access exceeds the first scope of data access.

4. The method of claim 1, wherein:
the first data access attributes define a first duration of data access granted to the client module;
the second data access attributes define a second duration of data access granted to the client module; and
the second duration of data access is longer than the first duration of data access.

5. The method of claim 1, wherein:
the first data access attributes define first data access capabilities granted to the client module;
the second data access attributes define second data access capabilities granted to the client module; and
the second data access capabilities represent expanded data access capabilities, relative to the first data access capabilities.

6. The method of claim 1, wherein the sending step also sends an assertion on behalf of the client module, the assertion facilitating authentication of the client module.

7. The method of claim 1, wherein the sending step also sends credentials of the client module, the credentials facilitating authentication of the client module.

8. The method of claim 1, further comprising the step of generating a POST request that includes the first access token, wherein:
the sending step sends the POST request; and
the receiving step also receives a redirect uniform resource locator that redirects the client module to access protected data resources.

9. The method of claim 1, further comprising the step of generating a GET request that includes the first access token, wherein:
the sending step sends the GET request;
receiving the second access token comprises receiving a redirect uniform resource locator that includes the second access token; and
the redirect uniform resource locator redirects the client module to access protected data resources.

10. A computer-implemented method of regulating access to protected data resources, the method comprising:
receiving a first access token at a server module, the first access token being associated with first data access attributes granted to a client module; and
in response to receiving the first access token, sending a second access token from the server module to the client module, the second access token being associated with second data access attributes granted to the client module, the first data access attributes and the second data access attributes being different.

11. The method of claim 10, wherein:
the first data access attributes define a first scope of data access granted to the client module;
the second data access attributes define a second scope of data access granted to the client module; and
the second scope of data access exceeds the first scope of data access.

12. The method of claim 10, wherein:
the first data access attributes define a first duration of data access granted to the client module;
the second data access attributes define a second duration of data access granted to the client module; and
the second duration of data access is longer than the first duration of data access.

13. The method of claim 10, wherein:
the first data access attributes define first data access capabilities granted to the client module;
the second data access attributes define second data access capabilities granted to the client module; and
the second data access capabilities represent expanded data access capabilities, relative to the first data access capabilities.

14. The method of claim 10, wherein:
the receiving step also receives an assertion on behalf of the client module; and
the method further comprises processing the assertion to authenticate the client module.

15. The method of claim 10, wherein:
the receiving step also receives credentials of the client module; and
the method further comprises processing the credentials to authenticate the client module.

16. The method of claim 10, wherein:
receiving the first access token comprises receiving a POST request that includes the first access token; and
the sending step also sends a redirect uniform resource locator that redirects the client module to access protected data resources.

17. The method of claim 10, wherein:
receiving the first access token comprises receiving a GET request that includes the first access token;
sending the second access token comprises sending a redirect uniform resource locator that includes the second access token; and
the redirect uniform resource locator redirects the client module to access protected data resources.

18. A server system comprising a processor and a memory, wherein the memory comprises computer-executable instructions that, when executed by the processor, cause the server system to:
receive a request on behalf of a client module, the request including credentials of the client module and a first access token associated with first data access capabilities of the client module, the first data access capabilities defining a restricted scope of data access for the client module;
authenticating the client module, using the credentials of the client module; and
in response to the authenticating, granting second data access capabilities to the client module, the second data access capabilities defining an expanded scope of data access for the client module, relative to the first data access capabilities.

19. The server system of claim 18, wherein the computer-executable instructions cause the server system to send a second access token to the client module, the second access token being associated with the second data access capabilities granted to the client module.

20. The server system of claim 19, wherein the computer-executable instructions cause the server system to send the second access token in conjunction with a redirect uniform resource locator that redirects the client module to access protected data resources.
